(19) United States
(12) Patent Application Publication
(10) Pub. No.: US 2026/0099055 A1
(43) Pub. Date: Apr. 9, 2026

(54) HEAD-UP DISPLAY

(71) Applicant: Panasonic Automotive Systems Co., Ltd., Kanagawa (JP)

(72) Inventors: Daiki KAWAI, Kanagawa (JP); Yusuke YONETANI, Hyogo (JP)

(73) Assignee: Panasonic Automotive Systems Co., Ltd., Kanagawa (JP)

(21) Appl. No.: 19/321,664

(22) Filed: Sep. 8, 2025

(30) Foreign Application Priority Data
Oct. 7, 2024 (JP) 2024-176176

(51) Int. Cl. G02B 27/01; B60K 35/234; B60K 35/81

(52) U.S. Cl. CPC G02B 27/0176; B60K 35/234; B60K 35/81

(57) ABSTRACT

Head-up display that performs local dimming control includes: a plurality of light sources that are mounted on substrate, and emit light; and display that changes the light emitted by the plurality of light sources into a display image, and emits the display image as display light, substrate includes first region and second region, the plurality of light sources include one or more first light sources mounted in first region and one or more second light sources mounted in second region, one or more first light sources provided in first region are turned on more frequently than one or more second light sources provided in second region, and heat dissipation of first region is higher than heat dissipation of second region.

### CROSS REFERENCE TO RELATED APPLICATION

The present application is based on and claims priority of Japanese Patent Application No. 2024-176176 filed on Oct. 7, 2024.

### FIELD

The present disclosure relates to a head-up display in a vehicle.

### BACKGROUND

As a conventional technique, a head-up display (HUD) having excellent visibility may be installed in a vehicle to cause a driver to recognize information related to the vehicle.

For example, Patent Literature 1 discloses a vehicle display device which includes a display which displays visible information, a white light emitting diode which illuminates the display, and at least one light reflector disposed on an optical path which guides light including the visible information displayed on the display to a predetermined projection surface.

### CITATION LIST

### Patent Literature

PTL 1: Japanese Unexamined Patent Application Publication No. 2012-58270

### SUMMARY

However, the above-described vehicle display device according to PTL 1 can be improved upon.

Hence, an object of the present disclosure is to provide a head-up display that is capable of improving upon the above related art.

A head-up display according to an aspect of the present disclosure is a head-up display that performs local dimming control, the head-up display includes: a plurality of light sources that are mounted on a substrate, and emit light; and a display that changes the light emitted by the plurality of light sources into a display image, and emits the display image as display light, the substrate includes a first region and a second region, the plurality of light sources include one or more first light sources mounted in the first region and one or more second light sources mounted in the second region, the one or more first light sources provided in the first region are turned on more frequently than the one or more second light sources provided in the second region, and heat dissipation of the first region is higher than heat dissipation of the second region.

According to the head-up display in the present disclosure, it is possible to improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic view showing an example of use of a head-up display according to an embodiment which is installed in a vehicle.

FIG. 2 is a perspective view showing the head-up display according to the embodiment.

FIG. 3A is a cross-sectional view showing the head-up display of a windshield type taken along line A-A in FIG. 2.

FIG. 3B is another cross-sectional view showing the head-up display of the windshield type.

FIG. 4 is an exploded perspective view showing a display unit.

FIG. 5 is an enlarged cross-sectional view showing the display unit.

FIG. 6 is an enlarged cross-sectional view showing the display unit in which a first heat dissipation mechanism is disposed for only a part corresponding to a first region.

FIG. 7 is a plan view showing the first region and a second region in a substrate on which a plurality of light sources are mounted.

FIG. 8 is a plan view showing a third region and a fourth region in a display.

FIG. 9 is an enlarged cross-sectional view showing a display unit which includes a first substrate and a second substrate.

FIG. 10 is a cross-sectional view showing a head-up display of a combiner type.

FIG. 11 is an enlarged cross-sectional view showing a display unit in a variation.

### DESCRIPTION OF EMBODIMENT

An embodiment will be specifically described below with reference to drawings.

The embodiment described below indicates a general or specific example. Numerical values, shapes, materials, constituent elements, the arrangement and connection of the constituent elements, and the like shown in the following embodiment are examples, and are not intended to limit the present disclosure. Among the constituent elements in the following embodiment, constituent elements which are not recited in the independent claim are described as optional constituent elements.

The drawings are schematic views, and are not exactly shown. In the drawings, the same constituent members are identified with the same reference signs.

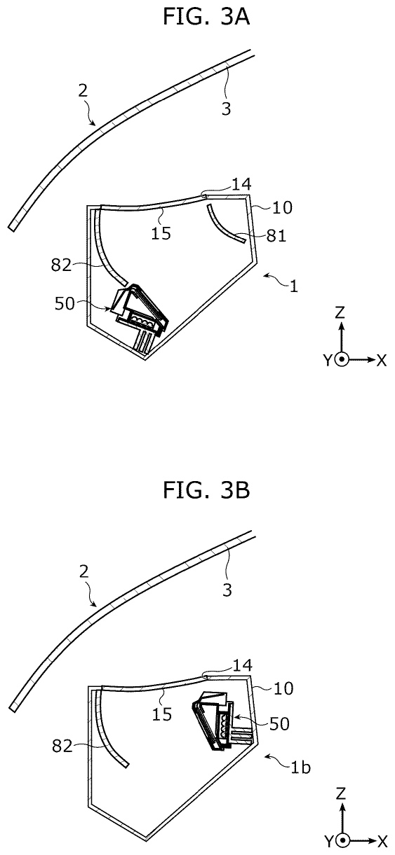

In the following description, in FIG. 2, the forward/backward direction of the vehicle of a head-up display is specified to be an X axis direction, a vertical direction orthogonal to the X axis direction is specified to be a Z axis direction, and a direction orthogonal to the X axis direction and the Z axis direction is specified to be a Y axis direction. In the drawings subsequent to FIG. 3A, the directions shown in FIG. 2 may be applied.

In the following embodiment, expressions such as a rectangular shape, substantially parallel, and the X axis direction are used. For example, the rectangular shape, substantially parallel, and the X axis direction mean not only completely rectangular, completely parallel, and a complete X axis direction but also substantially rectangular, substantially parallel, and a substantial X axis direction. In other words, the rectangular shape, substantially parallel, and the X axis direction also mean that a several percent error is included. In a range where effects in the present disclosure can be achieved, the rectangular shape, substantially parallel, and the X axis direction are provided as rectangular, parallel, and an X axis direction. The same is true for other expressions using “shape”, “approximate”, and “direction”.

### Embodiment

### <Configuration>

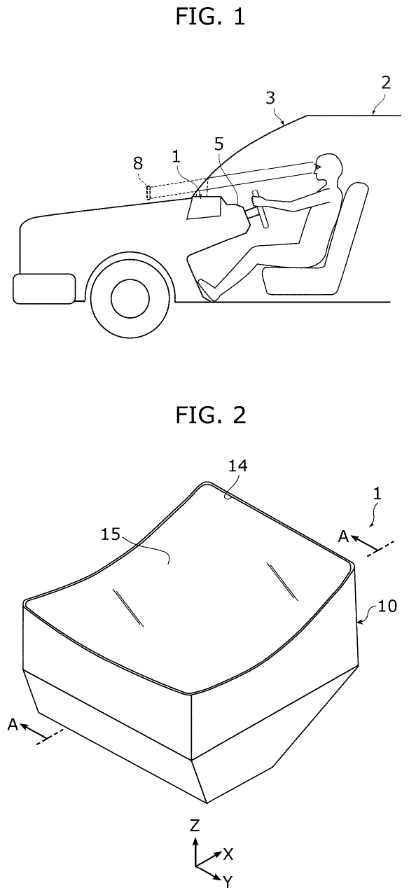

The configuration of head-up display 1 according to the present embodiment will first be described with reference to FIGS. 1 to 8.

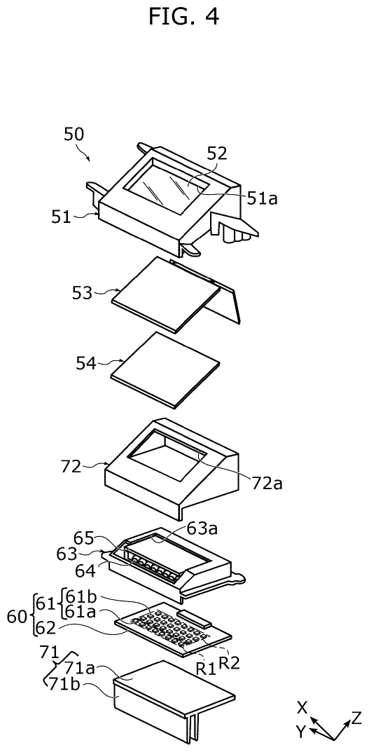

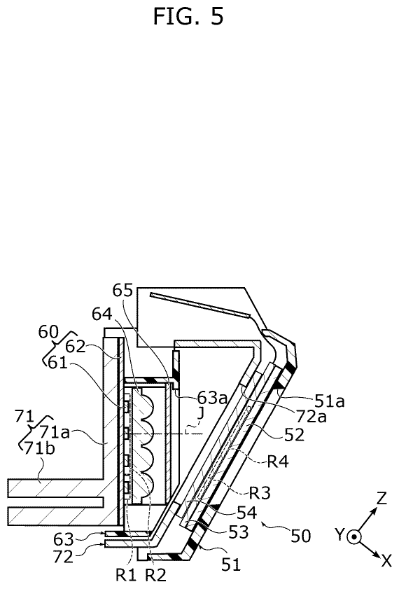

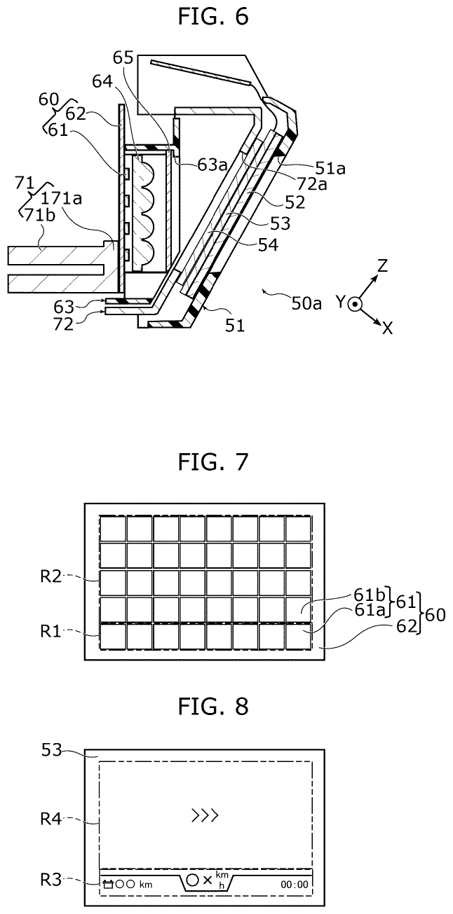

FIG. 1 is a schematic view showing an example of use of head-up display 1 according to the embodiment which is installed in vehicle 2. FIG. 2 is a perspective view showing head-up display 1 according to the embodiment. FIG. 3A is a cross-sectional view showing head-up display 1 of a windshield type taken along line A-A in FIG. 2. FIG. 3B is another cross-sectional view showing head-up display 1b of the windshield type. FIG. 4 is an exploded perspective view showing display unit 50. FIG. 5 is an enlarged cross-sectional view showing display unit 50. FIG. 6 is an enlarged cross-sectional view showing display unit 50 in which first heat dissipation mechanism 71 is disposed for only a part corresponding to first region R1. FIG. 7 is a plan view showing first region R1 and second region R2 in substrate 62 on which a plurality of light sources 61 are mounted. FIG. 8 is a plan view showing third region R3 and fourth region R4 in display 53. In display 53 shown in FIG. 8, a display image indicating a speed, guide arrows, and the like are displayed.

Head-up display 1 in the present embodiment may be a combiner type or the windshield type.

Head-up display 1 of the windshield type will first be described.

As shown in FIG. 1, head-up display 1 is disposed in, for example, dashboard 5 of vehicle 2 such as an automobile. Windshield 3 is disposed above dashboard 5 (also referred to as an instrument panel) of vehicle 2.

Head-up display 1 is a device which can project an image on windshield 3 for a user such as a driver or a passenger. In other words, head-up display 1 projects display light emitted by display unit 50 on windshield 3, and thereby can display an image indicated by the display light for the user. The display light is light which indicates a display image including numbers, characters, figures, and the like, and is displayed as virtual image 8 on windshield 3. Head-up display 1 in the present embodiment can perform local dimming control.

As shown in FIGS. 2 and 3A, head-up display 1 includes housing 10, light transmissive member 15, first reflective mirror 81, second reflective mirror 82, and display unit 50.

Housing 10 is a container which contains first reflective mirror 81, second reflective mirror 82, light transmissive member 15, and display unit 50. Housing 10 forms the outer shell of head-up display 1. Housing 10 is fixed to vehicle 2 in a state where housing 10 is attached inside dashboard 5 shown in FIG. 1. Housing 10 is formed of, for example, a resin such as polybutylene terephthalate (PBT).

An engagement portion for supporting display unit 50 is formed inside housing 10. In the present embodiment, display unit 50 is fixed to the engagement portion, and thus display unit 50 is fixed to housing 10.

In housing 10, housing opening 14 is formed in an end surface on the side of a Z axis positive direction. In housing opening 14, light transmissive member 15 is disposed. Specifically, light transmissive member 15 is fixed to housing 10 to cover housing opening 14. Light transmissive member 15 is located on the side of the Z axis positive direction relative to second reflective mirror 82 in an orientation where light transmissive member 15 is substantially parallel to an X-Y plane. In other words, light transmissive member 15 is located on an optical path of the display light between windshield 3 and second reflective mirror 82. Light transmissive member 15 is a translucent thin plate in which at least a part is curved.

Light transmissive member 15 also serves as an antifouling cover which suppresses the entry of dust, dirt, or the like into housing 10. For example, hard coat treatment may be performed on the surface of light transmissive member 15 on the side of windshield 3. In this case, even when dust, dirt, or the like is adhered to the surface of light transmissive member 15 (surface on the side of an X axis positive direction), it is easily wiped off.

As shown in FIG. 3A, first reflective mirror 81 is disposed on an optical path between display unit 50 and second reflective mirror 82, and second reflective mirror 82 is disposed on an optical path between first reflective mirror 81 and windshield 3 via light transmissive member 15.

Specifically, first reflective mirror 81 is disposed on the side of the X axis positive direction in housing 10 opposite the emission surface of display unit 50 disposed on the side of the X axis negative direction in housing 10. First reflective mirror 81 is disposed on the side of the Z axis positive direction relative to display unit 50. Second reflective mirror 82 is disposed on the side of the X axis negative direction in housing 10 opposite first reflective mirror 81 disposed on the side of the X axis positive direction in housing 10. In other words, second reflective mirror 82 is disposed side by side with first reflective mirror 81 along the X axis direction. Second reflective mirror 82 is disposed on the side of the Z axis positive direction relative to display unit 50 in the Z axis direction. First reflective mirror 81 and second reflective mirror 82 are disposed in housing 10 opposite each other in a state where they are spaced a predetermined distance.

As described above, first reflective mirror 81 and second reflective mirror 82 are disposed in housing 10, and thus the display light emitted by display unit 50 is incident on first reflective mirror 81 and is reflected off first reflective mirror 81, then is incident on second reflective mirror 82 and is reflected off second reflective mirror 82, and passes through light transmissive member 15 and is incident on windshield 3. The display light is applied to windshield 3, and thus an image is projected.

First reflective mirror 81 and second reflective mirror 82 are convex or concave mirrors. In the present embodiment, first reflective mirror 81 and second reflective mirror 82 are rectangular mirrors which are elongated in the Y axis direction. The shapes of first reflective mirror 81 and second reflective mirror 82 are not particularly limited, and they may be polygonal or circular.

Second reflective mirror 82 may be capable of swinging about the Y axis direction serving as an axis. In this case, the position of the image projected on windshield 3 can be adjusted. Second reflective mirror 82 may be capable of swinging by a manual operation or an electric operation using a drive mechanism.

As shown in FIGS. 4 and 5, display unit 50 emits the display light indicating information, and thereby can project the image indicated by the display light on windshield 3. Display unit 50 is, for example, a liquid crystal display device which includes a liquid crystal display or the like.

Specifically, display unit 50 includes light emitting module 60, first heat dissipation mechanism 71, lens support 63, lens cover 65, condenser lens 64, frame member 51, translucent cover 52, second heat dissipation mechanism 72, display 53, and heat dissipation light-transmissive member 54.

Light emitting module 60 includes a plurality of light sources 61 and substrate 62.

Light sources 61 are mounted on substrate 62 in an orientation where they emit light via condenser lens 64 and lens cover 65 toward translucent cover 52, display 53, heat dissipation light-transmissive member 54. Each of light sources 61 is formed with, for example, a light emitting diode (LED). For example, light sources 61 are driven by power obtained from a power supply (not shown) in vehicle 2. Light sources 61 are turned on according to an on signal from a controller installed in vehicle 2, and are turned off according to an off signal from the controller.

As shown in FIGS. 4 and 7, light sources 61 include one or more first light sources 61a mounted in first region R1 on substrate 62 and one or more second light sources 61b mounted in second region R2 on substrate 62. One or more first light sources 61a provided to correspond to first region R1 are turned on more frequently than one or more second light sources 61b provided to correspond to second region R2. In other words, the frequency of turning on of light sources 61 differs depending on the location thereof.

Substrate 62 may be a rigid substrate formed of a material such as glass epoxy, a ceramic substrate formed of a sintered member of a ceramic material such as alumina, a metal-based substrate obtained by applying an insulating film to the surface of a metal base material formed of a metal material such as aluminum or copper, a flexible substrate formed of a material such as a plastic film of polyimide, a liquid crystal polymer or the like, or the like.

Substrate 62 is coupled to lens support 63 in an orientation where substrate 62 is inclined downward in the X axis positive direction. A plurality of light sources 61 are mounted on the surface of substrate 62 on the side of condenser lens 64 and lens cover 65.

Specifically, substrate 62 includes first region R1 and second region R2. In first region R1, one or more first light sources 61a among light sources 61 are mounted, and in second region R2, one or more second light sources 61b among light sources 61 are mounted. One or more second light sources 61b are independent and separate from one or more first light sources 61a.

First heat dissipation mechanism 71 is fixed to the back surface of substrate 62 (surface on a side opposite to the side of light sources 61).

First heat dissipation mechanism 71 is a heat dissipation member which is formed of a material such as aluminum, iron, magnesium, or a heat dissipation resin.

Specifically, first heat dissipation mechanism 71 includes main body 71a and a plurality of fins 71b.

Main body 71a is a plate-shaped member which is disposed to be in close contact with the back surface of substrate 62. Fins 71b are formed on the surface of main body 71a on a side opposite to the side of substrate 62.

Fins 71b extend to rise from the surface of main body 71a on the side opposite to the side of substrate 62.

In first heat dissipation mechanism 71, heat generated by light sources 61 is conducted to main body 71a via substrate 62, is conducted from main body 71a to fins 71b, and is released to the outside air.

Here, first heat dissipation mechanism 71, substrate 62, and light sources 61 will be described in more detail.

As shown in FIGS. 5 and 6, first heat dissipation mechanism 71 is disposed to correspond to at least first region R1 on substrate 62. In other words, first heat dissipation mechanism 71 is in close contact with (thermally connected to) the back surface of substrate 62 to overlap at least first region R1 on substrate 62. Hence, the heat dissipation of first region R1 on substrate 62 is set higher than the heat dissipation of second region R2. FIG. 6 shows a case where first heat dissipation mechanism 71 of display unit 50a is disposed to correspond to only first region R1 on substrate 62. Specifically, main body 171a and fins 71b of first heat dissipation mechanism 71 are disposed to correspond to only first region R1 on substrate 62.

In the present embodiment, as shown in FIG. 5, first heat dissipation mechanism 71 may be disposed to correspond to first region R1 and second region R2 on substrate 62. In other words, first heat dissipation mechanism 71 may be in close contact with the back surface of substrate 62 to overlap first region R1 and second region R2 on substrate 62. In this case, the heat dissipation of first region R1 on substrate 62 is also set higher than the heat dissipation of second region R2. In other words, in first heat dissipation mechanism 71, the heat dissipation of a part corresponding to first region R1 on second region R2 may be designed to be higher than the heat dissipation of a part corresponding to second region R2 on substrate 62. Specifically, in first heat dissipation mechanism 71, the number of fins 71b formed in the part corresponding to first region R1 on second region R2 may be greater than the number of fins 71b formed in the part corresponding to second region R2 on substrate 62. In other words, the density of fins 71b formed in the part corresponding to first region R1 on second region R2 may be higher than the density of fins 71b formed in the part corresponding to second region R2 on substrate 62. In first heat dissipation mechanism 71, the thickness of main body 71a in the part corresponding to first region R1 on second region R2 may be greater than the thickness of main body 71a in the part corresponding to second region R2 on substrate 62.

As described above, the size of first heat dissipation mechanism 71 may be changed according to the frequency of turning on of light sources 61. In other words, in a region where the frequency of turning on of light sources 61 is higher, the size of first heat dissipation mechanism 71 disposed to correspond to this region may be increased.

As described above, since one or more first light sources 61a provided in first region R1 are turned on more frequently than one or more second light sources 61b provided in second region R2, the amount of heat generated by one or more first light sources 61a provided in first region R1 is higher than the amount of heat generated by one or more second light sources 61b provided in second region R2. However, as described above, the heat dissipation of first region R1 on substrate 62 is higher than the heat dissipation of second region R2, and thus an increase in the temperature of first region R1 beyond the temperature of second region R2 is suppressed, with the result that the temperature of first region R1 can be expected to be equal to or less than the temperature of second region R2.

Lens support 63 is a member for supporting condenser lens 64 and lens cover 65. Lens support 63 is fixed to frame member 51 using a fastening member. Lens support 63 is disposed such that lens support 63 is overlaid on second heat dissipation mechanism 72, and thus a part thereof is covered by second heat dissipation mechanism 72.

In lens support 63, opening 63a is formed in a position opposite opening 72a in second heat dissipation mechanism 72. Opening 63a in lens support 63 is located on an optical path between light emitting module 60 and first reflective mirror 81.

In opening 63a in lens support 63, lens cover 65 and condenser lens 64 are disposed, and opening 63a in lens support 63 is covered by lens cover 65 and condenser lens 64. Opening 63a in lens support 63 is located to correspond to opening 72a in second heat dissipation mechanism 72. In other words, lens cover 65 and condenser lens 64 are located to correspond to translucent cover 52, display 53, and heat dissipation light-transmissive member 54.

Condenser lens 64 and lens cover 65 are disposed on the side of the direction of emission of the light emitted from light sources 61, and are disposed on an optical path between light sources 61 and translucent cover 52, display 53, and heat dissipation light-transmissive member 54.

Condenser lens 64 is a lens assembly which condenses the light emitted from light sources 61 toward heat dissipation light-transmissive member 54, display 53, and translucent cover 52 via lens cover 65. In the present embodiment, condenser lens 64 is supported by lens support 63 in an orientation where the center axes of a plurality of lenses included in condenser lens 64 substantially coincide with the optical axes J of light sources 61.

Condenser lens 64 is formed of glass, a transparent resin, and the like. In the present embodiment, condenser lens 64 is a convex lens.

Lens cover 65 is disposed in opening 63a to cover the lenses included in condenser lens 64. Specifically, lens cover 65 is located on a side of condenser lens 64 opposite to the side of light emitting module 60 (the side of the X axis negative direction), and is disposed in opening 63a in lens support 63 between condenser lens 64 and heat dissipation light-transmissive member 54.

In the present embodiment, condenser lens 64 and lens cover 65 are supported by lens support 63 in an orientation where condenser lens 64 and lens cover 65 are inclined downward in the X axis positive direction relative to a Y-Z plane. In other words, condenser lens 64 and lens cover 65 are in an orientation where they are substantially parallel to a plane orthogonal to the optical axes J of light emitting module 60.

Frame member 51 is a member for supporting translucent cover 52 in a predetermined orientation. Specifically, opening 51a is formed in frame member 51. Translucent cover 52 is fitted into opening 51a in frame member 51, and opening 51a in frame member 51 is converted by translucent cover 52. Hence, translucent cover 52 also serves as an antifouling cover. For example, hard coat treatment may be performed on the surface of translucent cover 52 on the side of first reflective mirror 81. In this case, even when dust, dirt, or the like is adhered to the surface, it is easily wiped off.

Frame member 51 is held by housing 10 in an orientation where translucent cover 52 is opposite first reflective mirror 81.

Frame member 51 includes a plurality of engagement portions (not shown) for engaging portions to be engaged in second heat dissipation mechanism 72. The engagement portions engage the portions to be engaged in second heat dissipation mechanism 72, and thus frame member 51 supports second heat dissipation mechanism 72.

Second heat dissipation mechanism 72 is a heat dissipation member which is formed of a material such as aluminum, iron, magnesium, or a heat dissipation resin.

Second heat dissipation mechanism 72 can function as first heat dissipation mechanism 71 capable of dissipating heat generated in display 53. Second heat dissipation mechanism 72 is overlaid on frame member 51, thus a part thereof is covered by frame member 51, and second heat dissipation mechanism 72 is supported by frame member 51. Specifically, in second heat dissipation mechanism 72, opening 72a disposed in a position opposite opening 51a in frame member 51 is formed. In other words, opening 72a in second heat dissipation mechanism 72 and opening 51a in frame member 51 are located on an optical path between light emitting module 60 and first reflective mirror 81.

In opening 72a in second heat dissipation mechanism 72, display 53 and heat dissipation light-transmissive member 54 are disposed, and thus opening 72a in second heat dissipation mechanism 72 is covered by display 53 and heat dissipation light-transmissive member 54. When second heat dissipation mechanism 72 is overlaid on frame member 51, second heat dissipation mechanism 72 and frame member 51 can sandwich display 53 and heat dissipation light-transmissive member 54 between second heat dissipation mechanism 72 and translucent cover 52 supported by frame member 51.

Heat dissipation light-transmissive member 54 is, for example, translucent heat dissipation glass, and is formed in the shape of a plate.

Heat dissipation light-transmissive member 54 is disposed between display 53 and second heat dissipation mechanism 72. Heat dissipation light-transmissive member 54 is overlaid on display 53, and thus one surface on a side (the side of the X axis positive direction) opposite to the side of light emitting module 60 is in close contact with display 53. Heat dissipation light-transmissive member 54 is attached to second heat dissipation mechanism 72 to cover opening 72a in second heat dissipation mechanism 72, and thus a part of the other surface on the side of light emitting module 60 (the side of the X axis negative direction) is in close contact with second heat dissipation mechanism 72. Hence, when the light emitted from light sources 61 is applied, and thus display 53 generates heat, the heat of display 53 is conducted to heat dissipation light-transmissive member 54, and is further conducted from heat dissipation light-transmissive member 54 to second heat dissipation mechanism 72. Since heat dissipation light-transmissive member 54 can dissipate the heat of display 53, it is possible to suppress an increase in the temperature of display 53.

Display 53 is a liquid crystal display element (also called a liquid crystal display (LCD)) such as a light transmissive or light semi-transmissive TFT liquid crystal display (thin film transistor liquid crystal display). Display 53 can change the light emitted by light sources 61 into a display image, and emit the display image as display light. Specifically, the light emitted by light emitting module 60 is applied to the back surface of display 53, and an emission surface serving as the surface (surface on the side of the X axis positive direction) of display 53 emits light due to the light which has passed through the interior of display 53. Here, display 53 emits, from the emission surface, the display light indicating the display image including numbers, characters, figures, and the like according to a control instruction from the controller installed in vehicle 2 shown in FIG. 1. For example, display 53 is driven by power obtained from the power supply (not shown) in vehicle 2.

Translucent cover 52, display 53, and heat dissipation light-transmissive member 54 described above are supported by frame member 51 and second heat dissipation mechanism 72 in an orientation where they are substantially parallel to a Z-Y plane which is inclined relative to the plane orthogonal to the optical axes J of light emitting module 60.

As shown in FIGS. 5 and 8, display 53 includes third region R3 and fourth region R4.

Third region R3 is a region where the light emitted from one or more first light sources 61a is incident. Hence, third region R3 corresponds to first region R1. Fourth region R4 is a region where the light emitted from one or more second light sources 61b is incident. Hence, fourth region R4 corresponds to second region R2.

Since the frequency of turning on in first region R1 is higher than in second region R2, it is said that the frequency of turning on in third region R3 is higher than in fourth region R4. Hence, third region R3 is in an environment where the temperature is easily increased as compared with fourth region R4.

Hence, at least third region R3 is thermally connected to second heat dissipation mechanism 72. In the present embodiment, fourth region R4 is also thermally connected to second heat dissipation mechanism 72.

In third region R3 corresponding to first region R1 in which the frequency of turning on is high, a display image in which the latest information needs to be constantly displayed is provided, and for example, in the case of a vehicle equipped with speed and active cruise control functions, display light indicating a display image of a vehicle ahead to be followed or the like is emitted. In fourth region R4 corresponding to second region R2 in which the frequency of turning on is low, a display image which needs to be displayed when vehicle 2 detects some information is provided, and for example, display light indicating a display image of guide arrows for a driving route, a road sign, and the like is emitted.

Although in the above description, substrate 62 is divided into the two regions, that is, first region R1 and second region R2, the present embodiment is not limited to this configuration. For example, substrate 62 may be divided into three or more regions including a third region or the like. Hence, substrate 62 may also be divided into three or more substrates in addition to first substrate 62a and second substrate 62b. Therefore, display 53 may also be divided into three or more regions in addition to third region R3 and fourth region R4. In this case, a plurality of regions on substrate 62, the number of substrates 62, and a plurality of regions in display 53 correspond one-to-one.

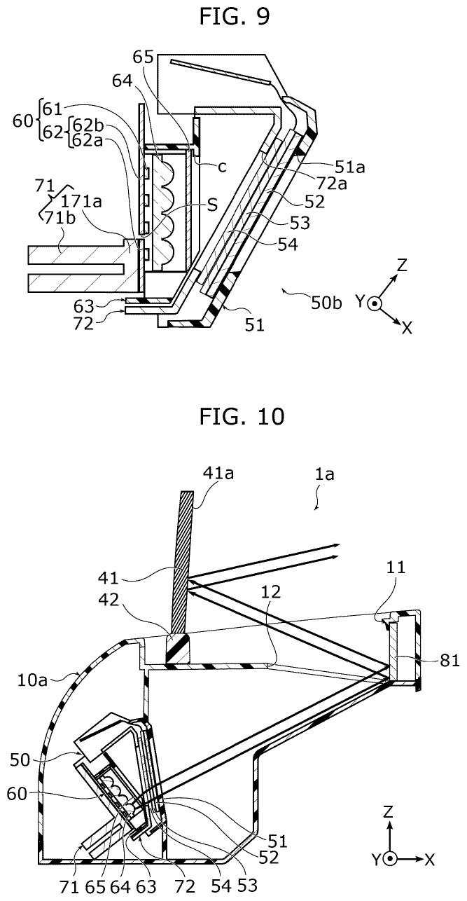

Although in the above description of the present embodiment, one substrate 62 of light emitting module 60 is mainly provided, substrate 62 may be divided into a plurality of substrates. Substrate 62 of display unit 50b will be described in more detail with reference to FIG. 9.

FIG. 9 is an enlarged cross-sectional view showing display unit 50b which includes first substrate 62a and second substrate 62b.

Substrate 62 may include first substrate 62a provided in first region R1 and second substrate 62b provided in second region R2. In other words, first substrate 62a corresponding to first region R1 and second substrate 62b corresponding to second region R2 may be independent and separate substrates 62. In this case, one or more first light sources 61a are mounted on first substrate 62a, and one or more second light sources 61b are mounted on second substrate 62b.

Gap S (air layer) may be formed between first substrate 62a and second substrate 62b. In other words, first substrate 62a is not connected to second substrate 62b, and thus heat is unlikely to be conducted from first substrate 62a where first light sources 61a in which the frequency of turning on is high are disposed to second substrate 62b where second light sources 61b in which the frequency of turning on is low are disposed.

Since the heat dissipation of first region R1 on substrate 62 is higher than the heat dissipation of second region R2, the heat dissipation of first substrate 62a may be higher than the heat dissipation of second substrate 62b. In this case, first substrate 62a may be formed of a material different from that of second substrate 62b. For example, a metal-based substrate having high heat dissipation may be used as first substrate 62a, and a substrate (such as a ceramic substrate or a flexible substrate) other than the metal-based substrate may be used as second substrate 62b.

Although in this case, first heat dissipation mechanism 71 may be disposed for at least first substrate 62a, first heat dissipation mechanism 71 may be further disposed for second substrate 62b.

As shown in FIG. 3B, head-up display 1b does not need to include first reflective mirror 81 shown in FIG. 3A. In this case, display unit 50 may be disposed on the side of the X axis positive direction relative to second reflective mirror 82 to be opposite second reflective mirror 82. Here, display unit 50 can directly emit the display light toward second reflective mirror 82.

Head-up display 1a of the combiner type which does not include combiner 41 will then be described with reference to FIG. 10.

FIG. 10 is a cross-sectional view showing head-up display 1a of the combiner type.

Head-up display 1a differs from head-up display 1 of the windshield type shown in FIG. 3A in that head-up display 1a does not include combiner 41 but includes second reflective mirror 82. In the description of head-up display 1a of the combiner type, the description of the same configurations as those of head-up display 1 of the windshield type shown in FIG. 3A is omitted as necessary.

Head-up display 1a of the combiner type further includes combiner 41 in addition to housing 10a, first reflective mirror 81, and display unit 50. Unlike head-up display 1 of the windshield type shown in FIG. 3A described above, head-up display 1a of the combiner type does not include second reflective mirror 82 and light transmissive member 15.

In a center part of housing 10a on the side of the Z axis positive direction, opening recess 11 for disposing combiner 41 is formed. Although combiner 41 can be displaced between an upright orientation and a lying orientation relative to housing 10a, opening recess 11 is formed to a size capable of containing combiner 41 when combiner 41 is in the lying orientation. When head-up display 1a is installed in dashboard 5 shown in FIG. 2, housing 10a is fixed to vehicle 2.

Opening recess 11 is a recess which is rectangular in plan view. Opening recess 11 is disposed between combiner 41 and display unit 50 to separate combiner 41 and display unit 50.

On opening recess 11 on the side of the Z axis positive direction, combiner 41 is disposed. A surface of opening recess 11 on the side of a bottom surface, that is, on the side of the Z axis positive direction is exposed from opening recess 11, and can be visually recognized from the outside of head-up display 1a. Opening recess 11 blocks external light, and blocks stray light generated by display unit 50 from being emitted to the outside of head-up display 1a via opening recess 11 of housing 10a.

In opening recess 11, a pair of support portions (not shown) for rotatably supporting combiner 41 are formed. The pair of support portions support both ends of combiner support portion 42 for fixing combiner 41 in the Y axis direction, and thereby rotatably support combiner 41 and combiner support portion 42. Specifically, combiner support portion 42 is formed in the shape of a bar which is elongated in the Y axis direction. Combiner support portion 42 is rotatably supported by the pair of support portions formed in opening recess 11 to be able to turn around an axis which is substantially parallel to the Y axis direction. Hence, when combiner support portion 42 is turned around the Y axis direction serving as the axis relative to opening recess 11, combiner 41 is likewise turned, and thus combiner 41 is brought into the upright orientation or the lying orientation.

Opening recess 11 includes cutout 12.

Cutout 12 is formed in opening recess 11 on the side of the X axis positive direction such that the display light emitted from display unit 50 passes through cutout 12 to be incident on first reflective mirror 81, and the display light incident on first reflective mirror 81 is reflected toward combiner 41.

Combiner 41 in head-up display 1 is disposed between dashboard 5 and windshield 3. Combiner 41 is, for example, a half mirror, and is formed of a plate member made of plate glass or a resin material and a light semi-transmissive film of aluminum or the like vapor-deposited or sputtered on one surface of the plate member made of plate glass or the resin material. Combiner 41 is semi-transmissive, and is formed such that the user can visually see the direction of travel of vehicle 2 through combiner 41. For example, combiner 41 is a projection plate or a recess plate.

Combiner 41 is a display panel in which the display light reflected off first reflective mirror 81 is projected, and thus virtual image 8 shown in FIG. 1 is displayed. Although combiner 41 is rectangular in plan view, its shape is not particularly limited, and combiner 41 may be, for example, polygonal or circular.

When combiner 41 is brought into the lying orientation, combiner 41 is stored in opening recess 11 of housing 10a. When combiner 41 is brought into the upright orientation, combiner 41 is brought into an upright state relative to opening recess 11. The storage state is a state where surface 41a of combiner 41 is substantially parallel to the X-Y plane. The upright state is a state where surface 41a of combiner 41 is substantially parallel to the Z-Y plane.

Surface 41a of combiner 41 is a projection surface on which the display light reflected off first reflective mirror 81 is incident, is a surface opposite the user, and is a surface on the side of the X axis positive direction.

First reflective mirror 81 is supported by housing 10a in an orientation where first reflective mirror 81 is substantially parallel to the Z-Y plane. First reflective mirror 81 is disposed in cutout 12 of opening recess 11 opposite display unit 50 and combiner 41. In the Z axis direction, first reflective mirror 81 is on the lower side (the side of the Z axis negative direction) of combiner 41 and on the upper side (the side of the Z axis positive direction) of display unit 50.

First reflective mirror 81 is disposed opposite display unit 50 and combiner 41, and thereby can reflect the display light emitted by display unit 50 toward combiner 41. Specifically, first reflective mirror 81 can reflect the display light emitted from display unit 50 toward surface 41a of combiner 41, that is, can project the display light on surface 41a of combiner 41.

First reflective mirror 81 is a convex or concave mirror. In the present embodiment, first reflective mirror 81 is a rectangular mirror which is elongated in the Y axis direction. The shape of first reflective mirror 81 is not particularly limited, and first reflective mirror 81 may be polygonal or circular.

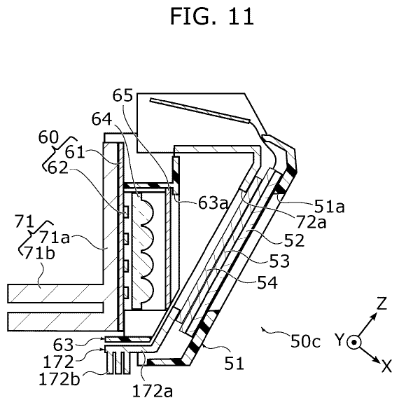

Second heat dissipation mechanism 172 will then be described with reference to FIG. 11.

For example, second heat dissipation mechanism 172 of the head-up display according to the embodiment described above may have a configuration shown in FIG. 11. FIG. 11 is an enlarged cross-sectional view showing display unit 50c in a variation. For example, second heat dissipation mechanism 172 may include main body 172a and a plurality of fins 172b provided on main body 172a.

### <Operational Effects>

Operational effects of head-up displays 1, 1a, and 1b according to the present embodiment will then be described.

However, in a conventional vehicle display device, when a white light emitting diode illuminates a display, the white light emitting diode may emit high brightness light. In this case, the amount of heat generated by the white light emitting diode is increased, and thus a large heat dissipation structure is used, with the result that the size of a head-up display is disadvantageously increased

In view of this, as described above, head-up display 1, 1a, or 1b in technique 1 according to the present embodiment performs local dimming control, and includes: a plurality of light sources 61 that are mounted on substrate 62, and emit light; and display 53 that changes the light emitted by light sources 61 into a display image, and emits the display image as display light, substrate 62 includes first region R1 and second region R2, light sources 61 include one or more first light sources 61a mounted in first region R1 and one or more second light sources 61b mounted in second region R2, one or more first light sources 61a provided in first region R1 are turned on more frequently than one or more second light sources 61b provided in second region R2, and heat dissipation of first region R1 is higher than heat dissipation of second region R2.

In this way, since the heat dissipation of first region R1 is higher than the heat dissipation of second region R2, even when the frequency of turning on of one or more first light sources 61a is high, heat generated by one or more first light sources 61a can be expected to be dissipated. Hence, even when heat dissipation mechanisms are provided for substrate 62, a configuration can be adopted in which a heat dissipation mechanism for a part corresponding to second region R2 is smaller than a heat dissipation mechanism for a part corresponding to first region R1, or the heat dissipation mechanism for the part corresponding to second region R2 is not provided.

Hence, in head-up display 1, 1a, or 1b, it is possible to suppress an increase in size. In particular, since an increase in the size of head-up display 1, 1a, or 1b can be suppressed, it is possible to suppress an increase in the manufacturing cost and the weight of head-up display 1, 1a, or 1b.

Head-up display 1, 1a, or 1b in technique 2 according to the present embodiment is head-up display 1, 1a, or 1b in technique 1, and further includes: first heat dissipation mechanism 71 that is thermally connected to substrate 62 to correspond to first region R1.

In this way, first heat dissipation mechanism 71 is only disposed to correspond to first region R1 where first light sources 61a in which the frequency of turning on is high are disposed, and thus it is possible to suppress an increase in the temperature of first region R1. Hence, as compared with a case where first heat dissipation mechanism 71 is disposed for first region R1 and second region R2, it is possible to suppress an increase in the size of head-up display 1, 1a, or 1b.

First heat dissipation mechanism 71 is disposed to correspond to first region R1 in which the frequency of turning on is high, and thus it is possible to suppress an increase in the temperature of first region R1. Hence, it is possible to suppress a decrease in the performance and the lives of one or more first light sources 61a caused by an increase in the temperature of one or more first light sources 61a.

Head-up display 1, 1a, or 1b in technique 3 according to the present embodiment is head-up display 1, 1a, or 1b in technique 1 or 2. In this case, substrate 62 includes first substrate 62a corresponding to first region R1 and second substrate 62b corresponding to second region R2, first substrate 62a is made of a material different from a material of second substrate 62b, and heat dissipation of first substrate 62a is higher than heat dissipation of second substrate 62b.

In this way, since one or more first light sources 61a which are frequently used are mounted on first substrate 62a which has heat dissipation higher than second substrate 62b, it is possible to suppress an increase in the temperature of one or more first light sources 61a and first substrate 62a.

In order to further increase the heat dissipation of first substrate 62a, first heat dissipation mechanism 71 is provided for first substrate 62a, and thus it is possible to suppress an increase in the temperature of one or more first light sources 61a and first substrate 62a. In this case, first heat dissipation mechanism 71 may be provided only for first substrate 62a, or the size of second heat dissipation mechanism 72 may be decreased beyond first heat dissipation mechanism 71, and it is possible to suppress an increase in the size of head-up display 1, 1a, or 1b accordingly.

As compared with a case where second substrate 62b (for example, an expensive metal-based substrate) which includes the same material as that of first substrate 62a is used, it is possible to suppress an increase in the manufacturing cost of head-up display 1, 1a, or 1b.

Furthermore, the size of first substrate 62a on which one or more first light sources 61a where the frequency of turning on is high are mounted can be minimized, and thus it is possible to suppress an increase in the size of first heat dissipation mechanism 71 and first substrate 62a, and to suppress an increase in the manufacturing cost of head-up display 1, 1a, or 1b.

Head-up display 1, 1a, or 1b in technique 4 according to the present embodiment is head-up display 1, 1a, or 1b in any one of techniques 1 to 3. In this case, substrate 62 includes first substrate 62a provided in first region R1 and second substrate 62b provided in second region R2, and gap S is provided between first substrate 62a and second substrate 62b.

In this way, since first substrate 62a is not connected to second substrate 62b, even when first substrate 62a where one or more first light sources 61a in which the frequency of turning on is high are disposed generates heat, the heat is unlikely to be conducted to second substrate 62b where one or more second light sources 61b in which the frequency of turning on is low are disposed.

Hence, substrate 62 is independently separated into a plurality of substrates 62 which are first substrate 62a corresponding to first region R1 and second substrate 62b corresponding to second region R2, and thus it is possible to easily suppress an increase in the temperature of one or more second light sources 61b and second substrate 62b.

Head-up display 1, 1a, or 1b in technique 5 according to the present embodiment is head-up display 1, 1a, or 1b in technique 2. In this case, substrate 62 includes first substrate R1 provided in first region R1 and second substrate 62b provided in second region R2, and first heat dissipation mechanism 71 is thermally connected to first substrate 62a.

In this way, even when first substrate 62a where one or more first light sources 61a in which the frequency of turning on is high are disposed is in an environment where the temperature is easily increased, first heat dissipation mechanism 71 can dissipate the heat, and thus it is possible to suppress an increase in the temperature of one or more first light sources 61a and first substrate 62a.

Head-up display 1, 1a, or 1b in technique 6 according to the present embodiment is head-up display 1, 1a, or 1b in any one of techniques 1 to 5. In this case, display 53 includes: third region R3 where light emitted from one or more first light sources 61a is incident; and fourth region R4 where the light emitted from one or more second light sources 61b is incident, and head-up display 1, 1a, or 1b further includes second heat dissipation mechanism 72 or 172 that is thermally connected to third region R3 in display 53.

In this way, since the light emitted from one or more first light sources 61a is incident on third region R3 corresponding to first region R1 in which the frequency of turning on is high, third region R3 is in an environment where the temperature of third region R3 is easily increased beyond fourth region R4 corresponding to second region R2 in which the frequency of turning on is low. However, in the present embodiment, third region R3 is thermally connected to second heat dissipation mechanism 72 or 172, and thus it is possible to suppress an increase in the temperature of third region R3.

Head-up display 1, 1a, or 1b in technique 7 according to the present embodiment is head-up display 1, 1a, or 1b in any one of techniques 1 to 6 that further includes: heat dissipation light-transmissive member 54 that is disposed between display 53 and second heat dissipation mechanism 72 or 172.

In this way, heat dissipation light-transmissive member 54 is overlaid on display 53, and thus one surface of heat dissipation light-transmissive member 54 is in close contact with display 53, and a part of the other surface of heat dissipation light-transmissive member 54 is in close contact with second heat dissipation mechanism 72 or 172. Hence, when display 53 emits light, heat dissipation light-transmissive member 54 can conduct the heat of display 53 to second heat dissipation mechanism 72 or 172. Therefore, heat dissipation light-transmissive member 54 can suppress an increase in the temperature of display 53.

### (Variations and the Like)

Although the present disclosure has been described above based on the embodiment, the present disclosure is not limited to the embodiment described above.

Embodiments obtained by performing various variations conceived by those skilled in the art on the embodiment and embodiments realized by arbitrarily combining constituent elements and functions in the embodiment without departing from the spirit of the present disclosure are also included in the present disclosure.

### Further Information About Technical Background to This Application

The disclosure of the following patent application including specification, drawings, and claims is incorporated herein by reference in their entirety: Japanese Patent Application No. 2024-176176 filed on Oct. 7, 2024.

### INDUSTRIAL APPLICABILITY

The head-up display in the present disclosure can be utilized, for example, in a moving unit such as a vehicle.

1. A head-up display that performs local dimming control, the head-up display comprising:
a plurality of light sources that are mounted on a substrate, and emit light; and
a display that changes the light emitted by the plurality of light sources into a display image, and emits the display image as display light,
wherein the substrate includes a first region and a second region,
the plurality of light sources include one or more first light sources mounted in the first region and one or more second light sources mounted in the second region,
the one or more first light sources provided in the first region are turned on more frequently than the one or more second light sources provided in the second region, and
heat dissipation of the first region is higher than heat dissipation of the second region.

2. The head-up display according to claim 1, further comprising:
a first heat dissipation mechanism that is thermally connected to the substrate to correspond to the first region.

3. The head-up display according to claim 1,
wherein the substrate includes a first substrate corresponding to the first region and a second substrate corresponding to the second region,
the first substrate is made of a material different from a material of the second substrate, and
heat dissipation of the first substrate is higher than heat dissipation of the second substrate.

4. The head-up display according to claim 1,
wherein the substrate includes a first substrate provided in the first region and a second substrate provided in the second region, and
a gap is provided between the first substrate and the second substrate.

5. The head-up display according to claim 2,
wherein the substrate includes a first substrate corresponding to the first region and a second substrate corresponding to the second region, and
the first heat dissipation mechanism is thermally connected to the first substrate.

6. The head-up display according to claim 1,
wherein the display includes:
a third region where light emitted from the one or more first light sources is incident; and
a fourth region where the light emitted from the one or more second light sources is incident, and
the head-up display further comprises a second heat dissipation mechanism that is thermally connected to the third region in the display.

7. The head-up display according to claim 6, further comprising:
a heat dissipation light-transmissive member that is disposed between the display and the second heat dissipation mechanism.
